(19) United States
(12) Patent Application Publication
(10) Pub. No.: US 2017/0336088 A1
(43) Pub. Date: Nov. 23, 2017

(54) System and Apparatus for Temperature Control

(71) Applicant: Hub Controls Ltd., Dublin 24 (IE)

(72) Inventor: Oliver Hynes, Dublin 24 (IE)

(21) Appl. No.: 15/522,327

(22) PCT Filed: Oct. 27, 2015
(86) PCT No.: PCT/EP2015/074902

§ 371 Date: Apr. 27, 2017

Related U.S. Application Data
(60) Provisional application No. 62/187,359, filed on Jul. 1, 2015.
(60) Provisional application No. 62/069,040, filed on Oct. 27, 2014.

(51) Int. Cl. F24F 11/00; G05D 23/19; G06Q 30/04

(52) U.S. Cl. CPC F24F 11/0012; G06Q 30/04; F24F 11/0086; G05D 23/1904; G05D 23/1923

(57) ABSTRACT

Methods, systems and apparatuses are disclosed to control heating and cooling costs. A Household Utility Bill (or HUB) controller, including a processor, may receive a user input indicating a budget for temperature control costs. A user may provide the user input using a touchscreen display. The touchscreen display may be included on the HUB controller. Further, the HUB controller may determine, at predetermined intervals, an estimated cost associated with operating a heating, ventilation, and air conditioning (HVAC) unit. The HUB controller may compare the estimated cost with the budget. The HUB controller may transmit, using a wireless communication unit, an electronic message to a predetermined user device, including a request to confirm shutting off the HVAC unit based on a determination that the estimated cost equals or exceeds the budget. After the HVAC unit is shut off, the HUB controller may remain active but an electromechanical valve may become inactive.

### CROSS REFERENCE TO RELATED APPLICATIONS

This application claims the benefit of U.S. Provisional Application Ser. No. 62/069,040 filed Oct. 27, 2014 and U.S. Provisional Application Ser. No. 62/187,359 filed Jul. 1, 2015, the contents of which are hereby incorporated by reference herein.

### FIELD OF INVENTION

The present invention relates to electronic control of heating, ventilation, and air conditioning (HVAC) systems.

### BACKGROUND

More than half of the energy use in a typical home goes toward heating and cooling, according to the U.S. Department of Energy (DOE). When looking to buy heating and cooling systems, homeowners often consider the latest options, the cost to buy them, how much energy they use, and the cost to operate them.

Vendors selling heating and cooling systems—central air conditioners, furnaces, boilers, and heat pumps—publish how much energy a product uses, as well as how it compares to similar models, at the point of sale. Manufacturers provide that information on a product's EnergyGuide label. However, depending on how a customer shops, they may not see the actual product and label, so the information on a website, a fact sheet, a brochure, or a directory may be missed by the customer.

Homeowners are typically advised to lower their thermostats in winter and raise it in the summer before going to bed or out for the day. Some programmable thermostats may allow a customer to set specific times of day to automatically adjust thermostat values.

These thermostats may be programmable to adjust values based on times of day. However, they do not track or account for the cost of energy. Accordingly, a smart thermostat that is configured to control heating and cooling of a home based on a predetermined budget is desired.

### SUMMARY

Methods, systems and apparatuses are disclosed to control heating and cooling costs. A Household Utility Bill (or HUB) controller, including a processor, may receive a user input indicating a budget for temperature control costs. A user may provide the user input indicating a budget for temperature control costs using a touchscreen display. The touchscreen display may be included on the HUB controller. Further, the HUB controller may determine, at predetermined intervals, an estimated cost associated with operating a heating, ventilation, and air conditioning (HVAC) unit. The HUB controller may compare the estimated cost with the budget. The HUB controller may transmit, using a wireless communication unit, an electronic message to a predetermined user device, including a request to confirm shutting off the HVAC unit based on a determination that the estimated cost equals or exceeds the budget.

After the HVAC unit is shut off, power may be reduced to the HUB controller and an electromechanical valve of the HVAC unit. The power may be reduced such that the HUB controller may remain active but the electromechanical valve may become inactive.

In another example, the HUB controller may receive a user input indicating a budget for home utility costs. The HUB controller may determine at predetermined intervals, an estimated cost associated with each of a plurality of home utility appliances. The HUB controller may then determine at predetermined intervals, an aggregated estimated cost associated with the plurality of home utilities based on an aggregation of the estimated cost associated with each of the plurality of home utilities. Further, the HUB controller may compare the aggregated estimated cost with the budget and shut off at least one of the plurality of home utility appliances if the aggregated estimated cost equals or exceeds the budget. Also, the HUB controller may transmit an electronic notification to a predetermined address notifying a user that at least one of the plurality of home utility appliances has been shut off. In a further example, the HUB controller may display the estimated cost associated with each of the plurality of home utility appliances and the aggregated estimated cost associated with the plurality of home utilities.

### BRIEF DESCRIPTION OF THE DRAWINGS

A more detailed understanding may be had from the following description, given by way of example in conjunction with the accompanying drawings wherein:

FIG. 1 is an example system architecture for a Household Utility Bill (HUB) controller system, including a power supply unit (PSU);

FIG. 2 shows an example system architecture for use with a HUB controller fitting into an ecosystem;

FIG. 3 shows an example home screen of the HUB controller;

FIG. 4 is an example map of the home screen of the HUB controller;

FIG. 5 shows an example messages screen of the HUB controller;

FIG. 6 shows an example settings screen of the HUB controller;

FIG. 7 shows an example of user initiated communications at the HUB controller;

FIG. 8 shows an example of pre-scheduled daily update requests from the device to the cloud engine;

FIG. 9 shows an example of user initiated communications on an external device;

FIG. 10 shows an example setup procedure for the HUB controller;

FIG. 11 shows an example home network architecture for use with a HUB controller fitting into an ecosystem; and

FIG. 12 shows examples of a budget screen of the HUB controller.

### DETAILED DESCRIPTION

The disclosed system evolves the smart home to not only control its climate but also control its own costs. The Household Utility Bill (or HUB) controller controls household utility bills through a combination of smart and cloud technology. It is the next generation of smart thermostat, delivering a value proposition that end-users want.

The HUB controller may save users money because it gives the householder control of the utility bill. The HUB controller shows the user the amount spent on their utilities in real-time, (e.g., today, yesterday, last week, last month and so on), and it allows them to set budgets for each appliance or an overall budget by day, week or month. The HUB controller may automatically manage the budget for the homeowner.

The HUB controller may learn the household routine and costs, and program itself. The HUB controller may be easy-to-install, which will lower the cost of installation because there is no need to dig up walls to have it installed. The HUB controller may be easy-to-control from anywhere. It can be controlled from anywhere via Mobile/Tablet/Phablet/personal computer (PC).

There are about 214 million households in the European Union (EU) and on average their incomes are falling behind inflation according to Eurostat. Recent reports show that energy bills increased rapidly across Europe in a recent 3 year period and by 37% in the United Kingdom (UK), and continue to increase rapidly. 127 million of these households have a broadband communications connection and an old Rheostat thermostat.

The HUB controller may be installed with only two (2) switch (or input) wires. This is an improvement since the vast majority of consumers are reluctant to commit to an installation that means digging out their walls to install a power wire, when a three (3) wire system is required. Because the HUB controller may be the only smart thermostat that overcomes a need for three (3) wires to install, users may avoid installation “hacks” and reduce installation time and complexity. This may be accomplished, for example, using combination of quiescence and battery technology to deliver power to the HUB controller. In one scenario, the HUB controller may tap into power from the electrical circuit both when the heating system may be off and when it may be on.

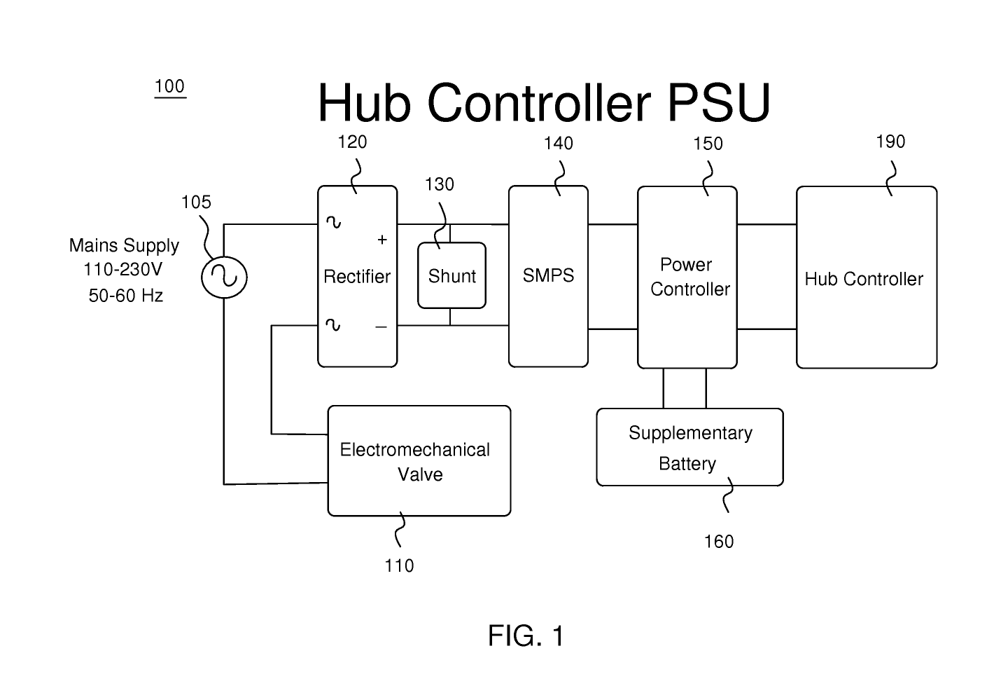

FIG. 1 shows an example system architecture for a HUB controller system, including a power supply unit (PSU). An example principle of operation of the PSU may include the following steps. Power may be provided to the circuit in series with the downstream electromechanical valve 110. When the electromechanical valve 110 is desired to be maintained in the off position, the electronic shunt 130 may be deactivated and the power draw to the HUB controller 190 may be maintained at a sufficiently low level for the electromechanical valve 110 to remain inactive.

When the electromechanical valve 110 is desired to be turned on, the shunt 130 may be activated, increasing current flow in the primary loop and thereby permitting the electromechanical valve 110 to operate normally. The electromechanical valve 110 may then, for example, engage in heating or cooling operations. A supplementary battery 160 may ensure a consistent power rail to the power controller for operational stability, and supplement operation at times of high power requirements, when drawing directly from the main loop would cause an undesired response from the electromechanical valve 110. During normal operation, there may be sufficient power overhead from the main loop to charge the battery without affecting the electromechanical valve 110 position.

In an example use of architecture 100, the PSU may include a main power supply 105 which may provide power. The main power supply 105 may operate at 110 through 230 volts (V) and at 50 through 60 Hertz (Hz). The main power supply may connect directly to the electromechanical valve 110. Further, the main power supply 105 may connect in series to a rectifier 120, the shunt 130, a switched mode power supply (SMPS) 140, the power controller 150 and the HUB controller 190. The power controller 150 may be connected to the supplementary battery 160. The supplementary battery 160 may be rechargeable.

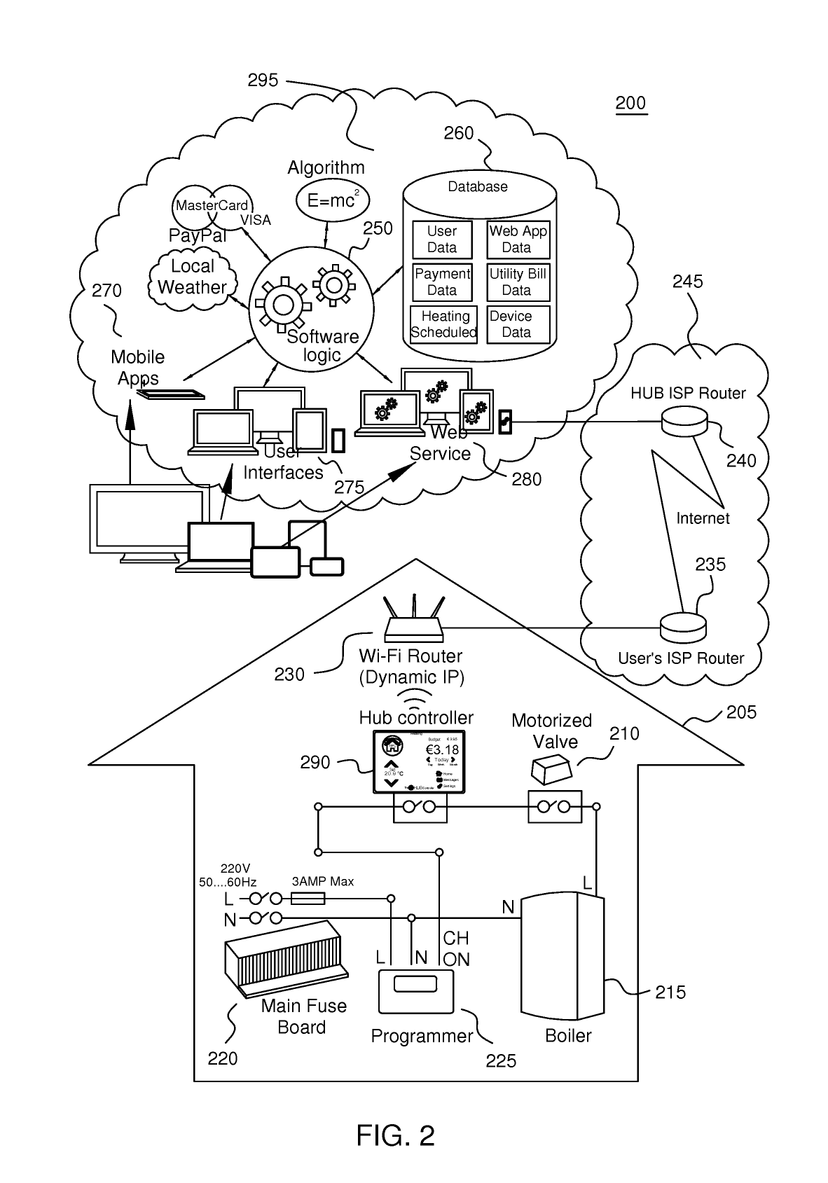

FIG. 2 shows an example system architecture for use with a HUB controller fitting into an ecosystem. This architecture 200 may be used to understand the various integrations that are required. As shown in FIG. 2, the system may include the user's home network 205, a communications network (e.g., the Internet) 245, and a Hub cloud engine 295.

The user's home network 205 may include the HUB controller 290, the heating, ventilation, and air conditioning (HVAC) system or related appliances such as a boiler 215 controlled by the HUB controller 290, and the Wi-Fi Router 230, using a dynamic Internet Protocol (IP) address, that the HUB controller 290 uses to send communications onto the communications network 245. The HUB controller 290 may control a motorized valve 210 in order to operate the boiler 215 (or other HVAC system). The boiler 215 (or other HVAC system) may be powered by the user's main fuse board 220. The boiler 215 (or other HVAC system) may connect to the main fuse board through a user's pre-installed programmer (or time clock) 225. The HUB controller 290 may also control the programmer 225. In an example, once the HUB controller 290 is installed by the user, the user may no longer need to use the programmer 225 and the HUB controller without the programmer may control the boiler 215 and/or other utilities of the user. The communications network 245 may include wired or wireless connections, such as the user's Internet Service Provider (ISP) router 235 and the HUB ISP router 240, between the HUB web service 280 and the user's Wi-Fi Router 230, and the Internet based devices the user may use to communicate with their HUB controller 290 device.

The HUB cloud engine 295 may include the cloud based components configured to manage, administer and deliver the system both to the user and to the device in the user's home. The HUB controller 290 may communicate with the cloud engine 295 on a regular basis. Further, the HUB controller 290 may communicate with the cloud 295 on a continuous or almost continuous basis. The cloud 295 engine may be configured to store and use an intelligence algorithm as part of its software logic 250. The software logic 250 may also access a database 260 for use in controlling the boiler 215, one or more other HVAC system(s) or other utilities of the user. The software logic 250 may communicate with the HUB controller 290 through the HUB web service 280. The user may communicate with the software logic 250 through the HUB controller 290 and the HUB web service 280. The software logic 250 may also communicate with the user through mobile applications 270 and user interfaces 275. The software logic 250 may include payments processing, such a through VISA, MASTERCARD or PAYPAL, and local weather forecasting. The local weather forecasting may assist the user and HUB controller 290 to properly program utilities settings.

The Hub controller 290 may be configured to contact the cloud engine 295 daily to get an update of the information it requires tomorrow. For example, the HUB controller 290 may transmit a message including the device serial number and the user's login credentials for security and identification purposes. The HUB controller 290 at a predetermined time each day (e.g., 23.59 hours), may send a request to the cloud engine 295 for an update. The HUB controller device 290 may send this information to the cloud engine 295 using a hypertext transfer protocol (HTTP) GET to an “UpdateDevice” action on the web service using a RESTful Interface.

The HUB controller device 290 may be easily updatable and upgradeable using over the air firmware updates. This may include adjustments to the screens and logic.

While the example shown in FIG. 2 is directed towards controlling heating costs, the HUB controller 290 may also be configured to integrate all utility bills into the same control portal via add on devices such as switches, sockets, etc. The HUB controller 290 may integrate with Wi-Fi enabled thermostatic radiator valves (TRVs), Wi-Fi enabled hot water thermostats, Wi-Fi enabled electricity monitors, etc. The HUB controller 290 may communicate with these utility devices to determine the usage of the respective utility and determine the respective utility spend based on that usage. The HUB controller may then display this utility spend. The HUB controller may also display the spend of other utilities and may aggregate and display a combined spend for all of the utilities of the user. Further, the HUB controller may control or limit an appliance of a utility based on the spend for that utility and/or the aggregate spend. For example, if the home reaches the required temperature the system may be automatically turned off. However, if the budget is less than or equal to the spend, the system may also turn off automatically.

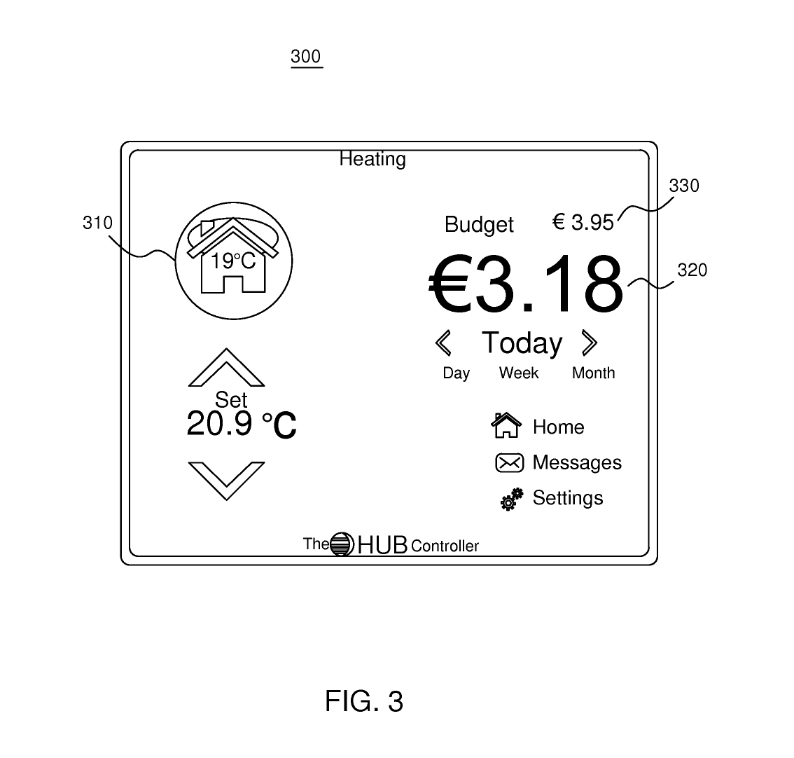

FIG. 3 shows an example home screen of the HUB controller. While the example shown in FIG. 3 shows the housing and screen of the HUB controller, the HUB controller may include a Real Time Clock (RTC) Module, a wireless communications unit or module such as a Wi-Fi module, microprocessor (or processor) and microcontroller, reset switch, temperature and humidity sensor, memory, power source, motion sensor, Micro USB port, touch screen display, ZigBee interface, speaker, and housing.

The touch screen display 300 may be mounted onto the housing which may then be mounted on a wall in the user's home. The HUB controller may provide the user with display information and control information. The HUB controller may have configurable inputs that may be in the form of icons and that the user may select by using the touch screen display. In an example, this may be the only means of input for the device; however, a way to reset the system to factory settings may also be configured. The touch screen display 300 may display the current indoor temperature 310, the budget 330 for a time period, shown as today in example screen 300, and the spend 320 for the time period. The time periods may include, for example, the day, the week, the month or other time periods.

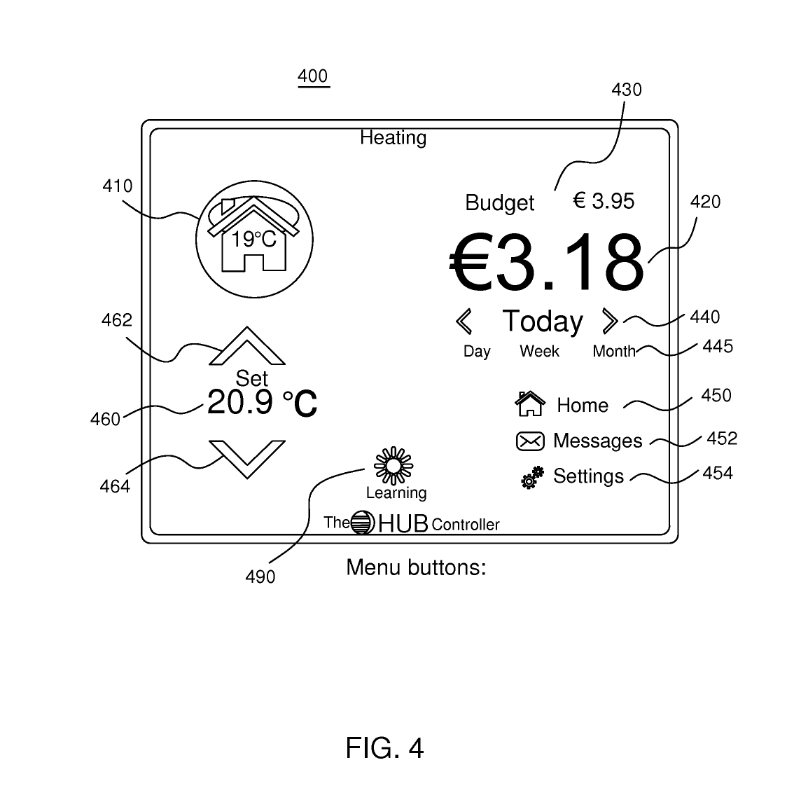

FIG. 4 is an example map of the home screen of the HUB controller. As shown in example screen 400, there may be multiple displays and buttons, including a learning spinner 490, a system button 410, a home temperature indicator, a set temperature increase button 462, a set temperature indicator 460, a set temperature decrease button 464, a budget display 430, a spend display 420, a display period indicator 440, display period adjustment buttons 445, and menu buttons (which may include home 450, messages 452 and settings 454 buttons). The list of buttons described above is a non-exhaustive list and is for example only, as the HUB controller may include more or fewer buttons.

The learning spinner 490 may be configured to appear when the user turns the system on or off, or increases or decreases the Set Temperature. The HUB controller may then send this information to the cloud engine and the learning spinner appears 490.

By selecting the system button 410 the user can turn the heating, or other utility, on or off. The touch screen display may be configured to change the icon color of system button 410 to notify the user that the input has completed. For example, the system button 410 may be colored green to indicate the heating system may on. Touching this system button 410 may turn the system off and the button may change from green to red. If the system button 410 is orange the heating system may be on standby, waiting for the user to turn it on. Touching the system button 410 may turn the system on and the system button 410 may change to green. If the system button 410 is red, the heating system may be off. Touching the system button 410 may turn the system on and the system button 410 may change to green.

The home temperature indicator indicates the current home temperature. The home temperature indicator may be located within system button 410, as shown in example screen 400. The set temperature indicator 460 indicates the current temperature that may be set by the user or the schedule. To control the heating the user may select the preferred temperature by selecting the set temperature increase button 462 and the set temperature decrease button 464.

The HUB controller may also include a budget indicator 430 that indicates the budget for the day, week or month (if the user has set a budget). Additionally a spend indicator 420 may indicate the actual amount spent for the day, week or month. The spend indicator 420 may be configured to turn red when the budget has been reached. This may also trigger the HUB controller to turn off the HVAC system. In an example, The HUB controller may then deactivate the shunt to turn off the HVAC system. In another example, the HUB controller may send a turn off message to the HVAC system and/or appliance.

The display period button 440 may allow a user to select which Day, Week or Month to display by scrolling back and forward. For example, if the user chooses “Day”, then “Today” may display automatically, by using the back button the user can see Yesterday etc. The “Day”, “Week” & “Month” buttons 445 may allow the user to select to display daily, weekly or monthly information.

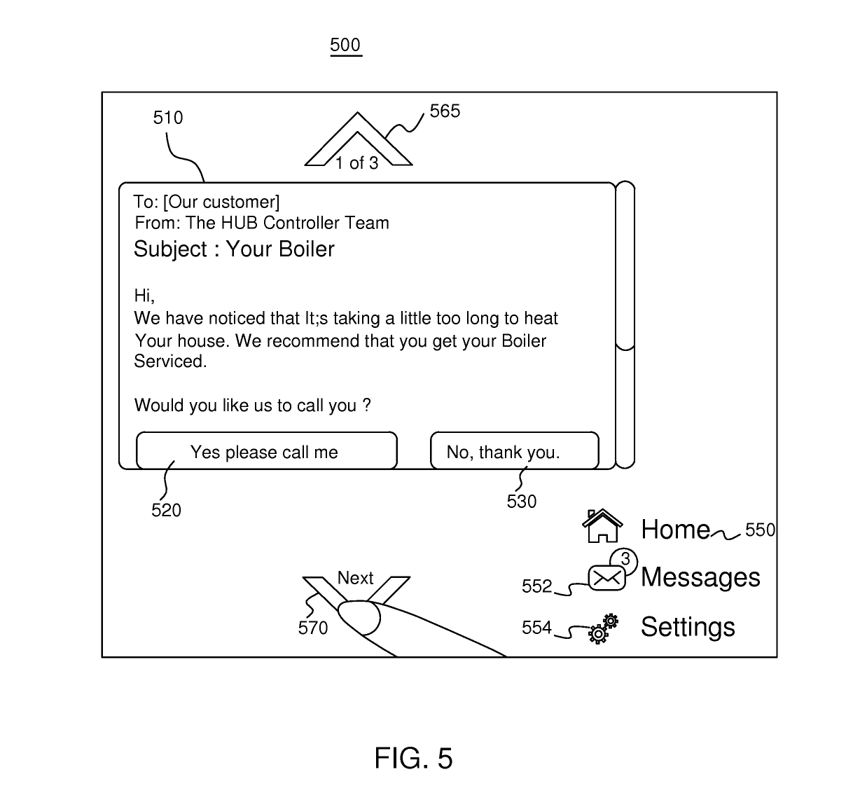

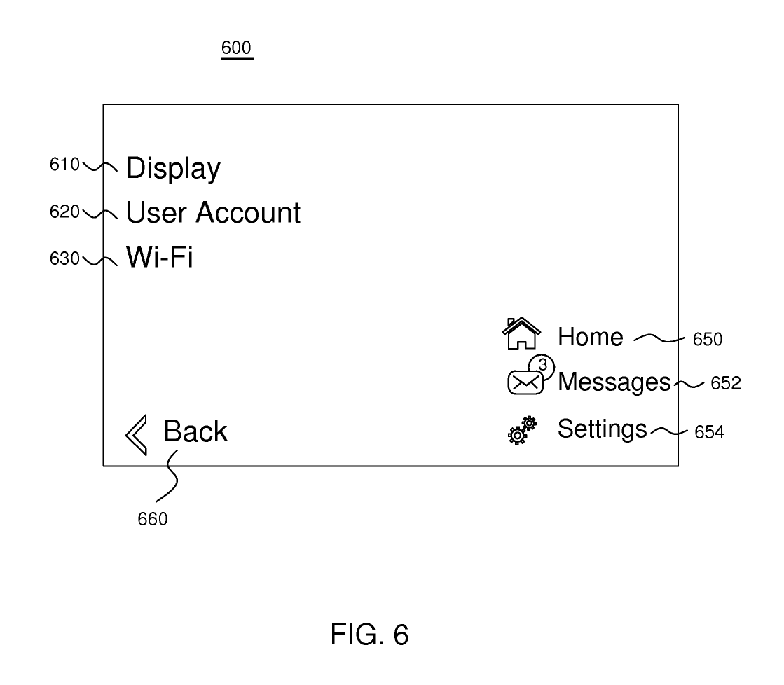

The user may navigate through screens by using the menu buttons, which may include home 450, messages 452 and settings 454 buttons. The home button 450 may take a user to the home screen. The messages button 452 may take a user to a messages screen, such as the messages screen shown in FIG. 5, to display all message sent to the HUB controller that are unread. The settings button 454 may take a user to a settings screen, such as the screen shown in FIG. 6, to allow a user to change the setting on the HUB controller.

In one example scenario, the utility company may send out a meter reader to determine a user's utility usage. This meter reader may be sent out at various intervals throughout the year. Based on the meter reading, the utility determines an expected usage and bills the user based on a unit cost that is determined based on the expected usage. As Europe moves to smart meters, utility companies may adjust how they determine cost, however, users will still likely be charged based on unit costs of energy usage.

The HUB controller may be configured to determine costs using multiple methods. In one example, a sensor associated with a boiler determines gas/minute that is being used. This information may be communicated to the HUB controller directly by the sensor. The HUB controller may further prompt the user to enter in unit costs for gas use. The HUB controller may then use this information to determine cost estimates for use with the cost control features. In an example, the HUB controller may save this information for future use. In another example, the HUB controller may use the gas/minute used and the unit cost for gas to determine a spend of the boiler. In yet another example, the HUB controller may transmit gas/minute used, the unit cost for gas, the type of boiler, and/or other information to the HUB cloud engine for use in determining the spend of the boiler. The HUB cloud engine may also use information in its database to determine or help determine the spend of the boiler. The HUB cloud engine may determine the spend of the boiler and then transmit this spend information to the HUB controller. In another example, the HUB cloud engine may have recorded the unit costs for gas from other sources. In a further example, the HUB cloud engine may have recorded information regarding characteristics of the boiler and may use these characteristics to help determine the spend of the boiler. Similar sensors and methods may be used with other utilities.

As a general example, a sensor may determine a utility that is being used and transmit this information to the HUB controller. The HUB controller may further prompt the user to enter in unit costs for the utility used. The HUB controller may then use this information to determine cost estimates for use with the cost control features. In another example, the HUB controller may use the utility use/minute used and the unit cost for the utility to determine a spend of the appliance using the utility. In yet another example, the HUB controller may transmit utility use/minute used, the unit cost for the utility, the type of appliance and/or other information to the HUB cloud engine for use in determining the spend of the appliance. The HUB cloud engine may also use information in its database to determine or help determine the spend of the appliance. The HUB cloud engine may determine the spend of the appliance and then transmit this spend information to the HUB controller. In another example, the HUB cloud engine may have recorded the unit costs for the utility from other sources. In a further example, the HUB cloud engine may have recorded information regarding characteristics of the appliance and may use these characteristics to help determine the spend of the appliance.

For systems using smart meter technology, this information may all be automated. Additionally, the HUB controller may be linked with the user's online utility account.

In another example, the HUB controller may be configured with the expected efficiency specifications associated with an HVAC appliance. The HUB controller may be configured to determine efficiency based on energy usage and temperature readings. The HUB controller may then use this information to determine cost estimates for use with the cost control features. In an example, the HUB controller may transmit this information to the HUB cloud engine for use in determining the cost estimates and/or in helping to determine the cost estimates. The HUB controller may also be configured to advise the user that an appliance is in need of servicing.

The user of a HUB controller may further benefit from a database of information generated by the HUB system. For example, the HUB controller may be configured to track the rate at which temperature changes. In an example, the HUB controller may transmit this information to the HUB cloud engine for storage in the database of the HUB cloud engine. The HUB controllers of other users may similarly transmit information regarding the other users to the HUB cloud engine for storage in the database of the HUB cloud engine. The HUB cloud engine may make comparisons among the users regarding the efficiency of units. In an example, the HUB cloud engine may transmit information about the comparisons to the HUB controller of the user. In another example, the HUB cloud engine may transmit information from the database regarding the other users. The HUB controller may then make comparisons among the users regarding the efficiency of units. The HUB controller may notify the user that the temperature change is more or less efficient than similar units in similar houses.

FIG. 5 shows an example messages screen of the HUB controller. When a user selects the messages button on the home screen, such as messages button 452 shown in FIG. 4, the touch screen display may present a messages screen 500 as shown in FIG. 5. In an example, the messages button 552 may indicate how many messages remain unread. As part of a cloud subscription the user may receive periodic messages from HUB Controls Ltd., such as a message in message area 510. A simple accept or decline may be required. For example, the user may ask the HUB controller team to call the user by pressing the positive icon 520 or may decline such a call by pressing the negative icon 530. In this message area 510, the user can read messages sent by HUB Controls or approved 3rd parties. The user may also navigate back to the home screen using the home button 550 or to the setting screen by using the settings button 554.

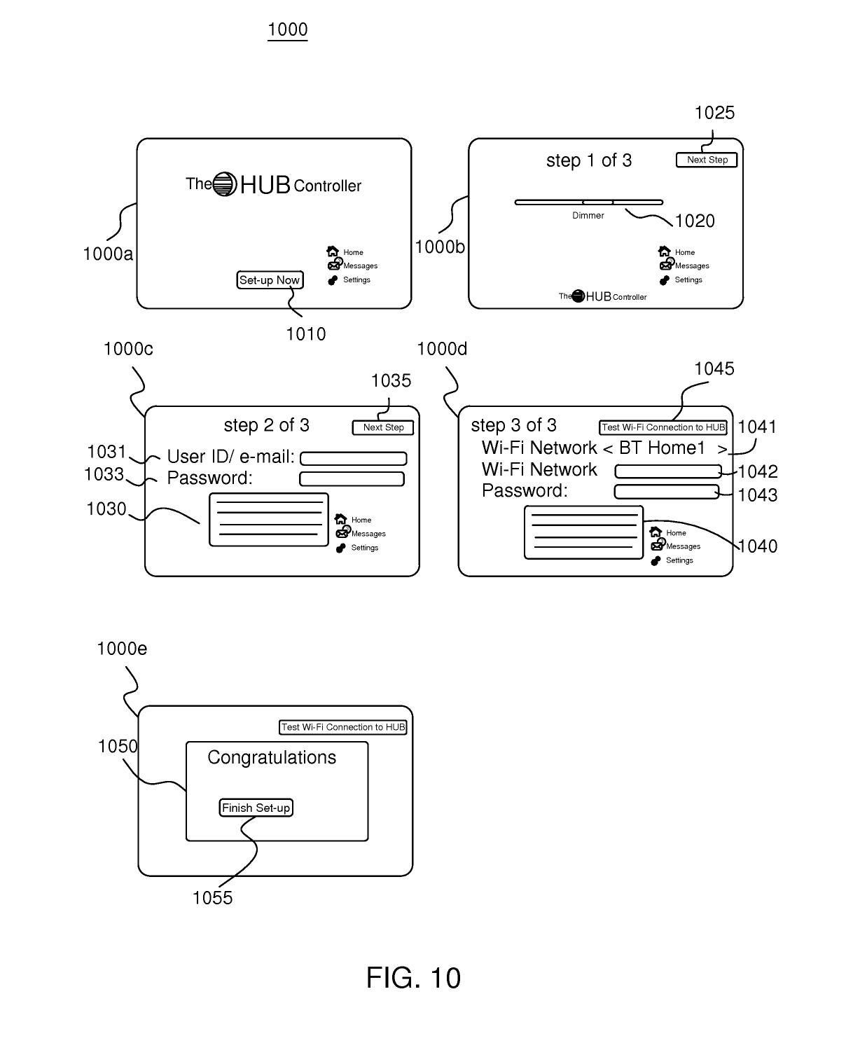

FIG. 6 shows an example settings screen of the HUB controller. When a user selects the settings button on the home screen, the touch screen display may present a settings screen 600 as shown in FIG. 6. The user may be able to view and modify display Settings, user account settings, Wi-Fi connection settings and other settings. The user may be able to view and modify display settings by pressing the display button 610 and then modifying the display settings as shown in an example in screen 1000b in FIG. 10. The user may be able to view and modify user account settings by pressing the user account button 620 and then modifying the user account settings as shown in an example in screen 1000c in FIG. 10, user account settings. The user may be able to view and modify Wi-Fi connection settings by pressing the Wi-Fi button 630 and then modifying the Wi-Fi connection settings as shown in an example in screen 1000d in FIG. 10. The user may also navigate back to the home screen using the home button 650 or the messages screen using the messages button 652. In an example, the user may also remain on and/or refresh the setting screen by using the settings button 654. The user may also return to the previous screen by pressing the back button 660.

The user may modify various settings of the HUB controller. This may include, for example:
a. The unit of currency;
b. The Terms & Conditions;
c. Dimmer settings;
d. Display time delay settings;
e. Language setting, wherein the screen language may be adjusted among any available language (e.g., English, French, Spanish, Italian, German, Chinese, Portuguese, Greek, Arabic, Russian, Polish, Dutch, Japanese, Hebrew, Danish, Swedish & Norwegian);
f. User account settings (e-mail address and password);
g. Wi-Fi Settings including the code to discover Wi-Fi networks;
h. Keyboards, alpha-numeric in all languages;
i. Device details: Serial number, MAC Address etc.; and
j. All messages received including the ID of each message.

The user may also be able to adjust the heating schedule, wherein this setting may be a temperature (e.g., 22.0° C. or 5° C.) for every minute of each day, Sunday to Saturday (7 days). This adjustment may be performed, for example, by a number of devices, including a personal computer, mobile phone, tablet, phablet, HUB controller (including the HUB controller's touchscreen display), and the like.

The user may also be able to adjust the spend schedule, wherein this setting may be a money amount (e.g., [symbol] 2.34 (E.U.) or £5.66 (UK)) for each day of the last 180 days. It may also contain 180 days of Budget amounts corresponding to each spend amount (e.g., Last Monday: Spend= [symbol] 2.61 & Budget= [symbol] 2.50). In another example, the spend schedule may be fixed or selected by the system.

The user may also be able to adjust the Budget Schedule, wherein this setting may be a money amount (e.g., [symbol] 2.99 (E.U.) or £6.80 (UK)) for every weekday (for example, Sunday, Monday, and the like), for each week and for each month for future dates starting from today and going forward up to 12 months or 52 weeks. The user can set the budget by amount (which may be a dollar value) or the user may also be able to select a percentage (e.g., reduce the bill by 10%). This adjustment may be performed, for example, by a number of devices, including a PC, mobile phone, tablet, phablet, HUB controller (including the HUB controller's touchscreen display), and the like.

The user may also be able to adjust the cost per minute. The HUB controller may use a cost per minute (e.g., [symbol] 0.001257) in order to calculate the daily spend. (The historic spend may be held in the Spend Schedule.) In another scenario the user may change the ‘Unit Cost’ of the utility or the appliance (e.g., Worcester Bosch Boiler Eco 1200CDI). The HUB system may then automatically calculate the cost per minute. This adjustment may be performed, for example, by a number of devices, including a personal computer, mobile phone, tablet, phablet, HUB controller (including the HUB controller's touchscreen display), and the like.

The HUB controller offers a novel method to control a heating and cooling bill. The HUB controller may be configured to set a daily, weekly or monthly budget to be spent on heating and cooling. Additionally, the HUB controller may be configured to set the amount a user wants to save or a percentage (e.g.: save [symbol] 50 per month or 10% per week). Once set, the budget may appear in the top right of the screen. As soon as a user reaches a user's budget for the day, week or month, the amount of “Spend” will turn red. As soon as the Spend amount goes red, the System button may turn red and switch the utility (e.g., heating) system off, automatically. If a user wants, the user may override this and switch the system back on. As always, the HUB controller may go into “Learning” mode. The HUB controller may further be configured to send a ‘pop-up’ message before the heating system is reactivated (e.g., try wearing a sweater). In this way, the HUB controller may try to save a user money. The HUB controller may further be configured to track the accumulated number of minutes the system has been ON for a day.

Referring back to FIG. 2, the HUB controller 290 may be configured to communicate with the cloud engine 295 based on user initiated communications at the HUB controller device 290, pre-scheduled daily update requests from the HUB controller device 290 to the cloud engine 295, and user initiated communications on an external device such as a mobile phone, PC, tablet, phablet and the like. A computer based intelligence algorithm of the system may be used by the software logic 250 and stored in the cloud engine 295. The system may be configured to use dynamic IP addressing, which assigns a different IP address each time the ISP user logs on to their computer. This may be dependent upon the ISP as some ISPs only change the IP address when they deem it necessary. As such, the device may be dynamic host configuration protocol (DHCP) capable.

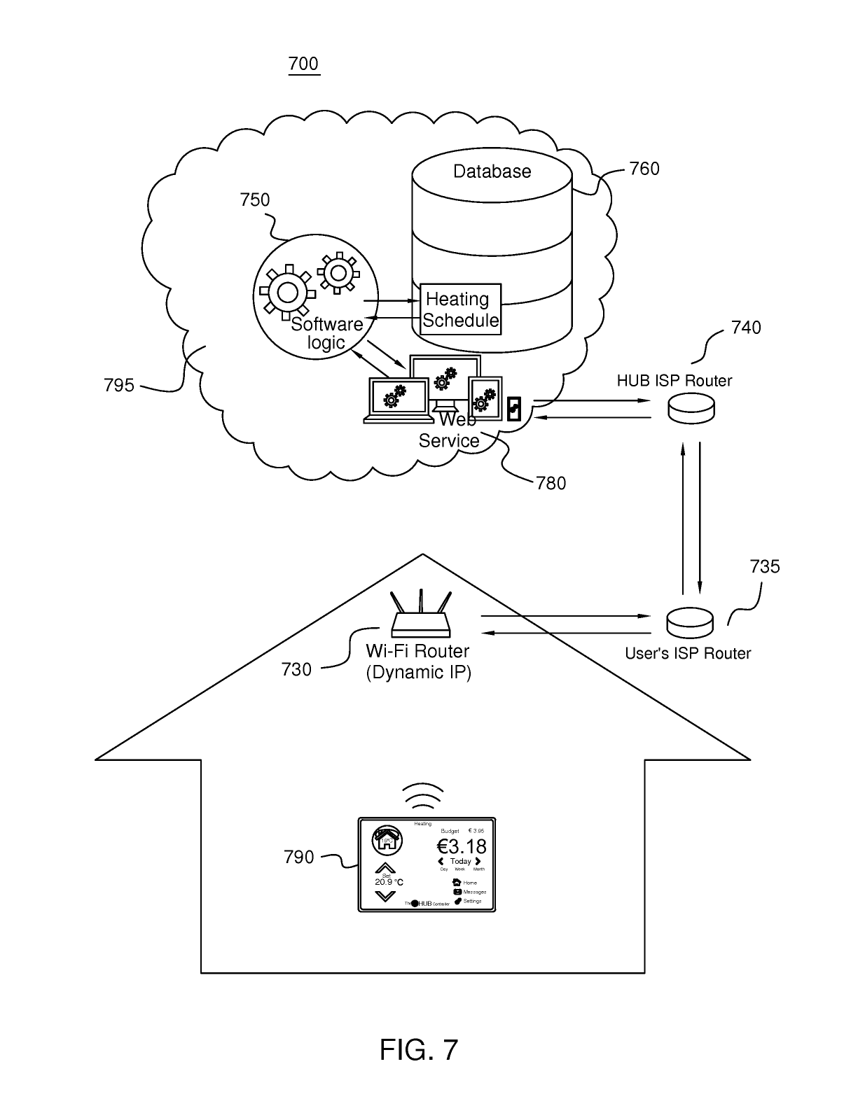

FIG. 7 shows an example of user initiated communications at the HUB controller. As shown in example architecture 700, when the user turns the system button on, the HUB controller 790 may make a DHCP request to establish an Internet connection. For example, the HUB controller 790 may communicate with the Wi-Fi router 730 of the user, which may then communicate the ISP router of the user 735, which may in turn communicate with the HUB ISP router 740, which then reaches the HUB cloud engine 795 through the HUB web services 780. In an example, the HUB controller device 790 may send a predetermined HTTP POST message to the HUB cloud engine 795 (IP Address may be static). The message may be received by the Web Service 780, tested for security and sent on to software logic 750 that may write the message to database 760. Database 760 may contain information about the utility systems of the user, such as the heating schedule of the user. A reply message may be sent back to the HUB controller device 790 to say the message was received OK.

There are several instances (initiated by the user at the device) that may use this type of communication. In these instances the device may send its own allocated serial number and the user's login credentials for security and identification purposes.

One example of a user initiated communication is when the user turns the system on or off. The device may send this information (ON or OFF, the Set Temperature and the property's current temperature) to the cloud engine using an HTTP POST to a “PowerUpdate” action on the web service using a RESTful Interface.

Another example of a user initiated communication is when the user turns the Set temperature up or down. The device may send this information (required temperature and current ambient temperature) to the cloud engine using a HTTP POST to a “SetTemperatureUpdate” action on the web service using a RESTful Interface.

Another example of a user initiated communication is when the user sets up the device at the beginning. When the user presses the “Test Wi-Fi Connection to HUB” icon, the device may send all the setup information to the cloud engine using an HTTP POST to a “DeviceSetup” action on the web service using a RESTful Interface.

Another example of a user initiated communication is when the user updates some settings. The device may send this information to the cloud engine using an HTTP POST to an “UpdateDeviceSettings” action on the web service using a RESTful Interface.

Another example of a user initiated communication is when the user reads a message on the device and touches the positive (e.g., “Yes, please call me”) icon or negative (e.g., “No, Thank you”) icon, such as the positive icon 520 and negative icon 530 shown in messages screen 500. The device may send this answer to the cloud engine using an HTTP POST to a “MessageAnswer—XXXXXX” action on the web service using a RESTful Interface. The “XXXXXX” may be a predetermined message number.

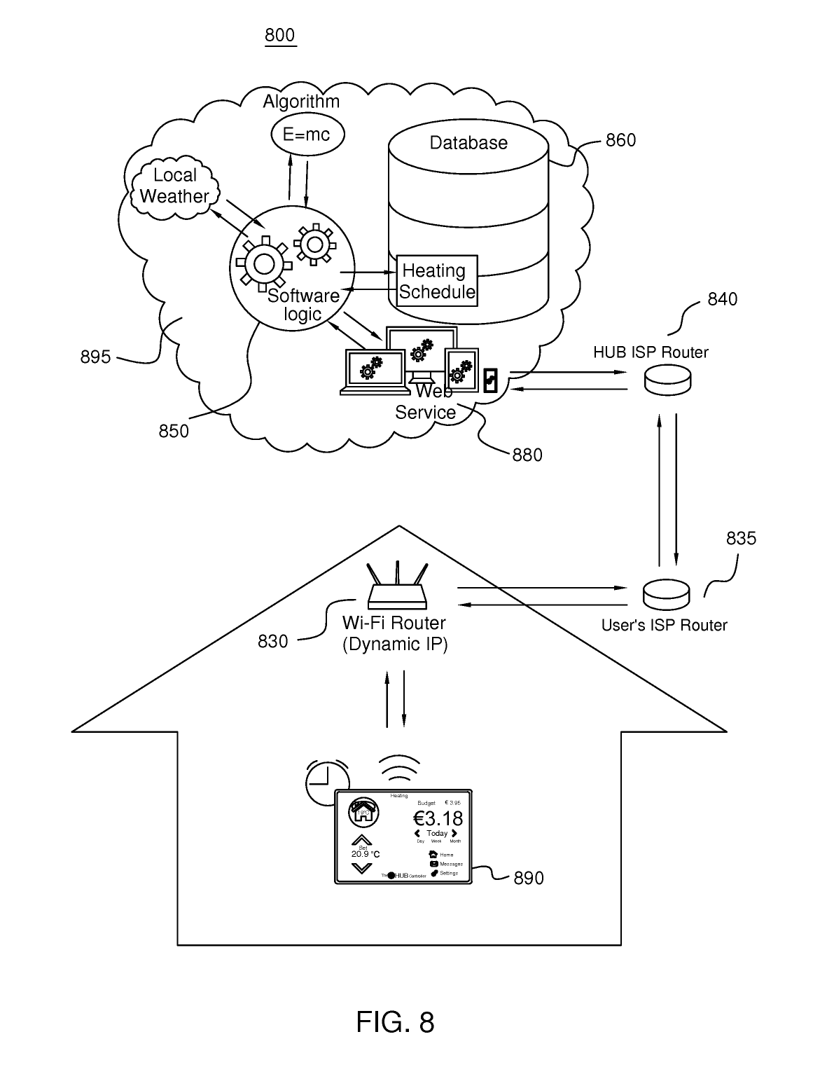

FIG. 8 shows an example of pre-scheduled daily update requests from the device to the cloud engine. The HUB controller 890 may be configured to send the device serial number and the user's login credentials for security & identification purposes. As illustrated in example architecture 800, the HUB controller 890 may communicate with the Wi-Fi router 830 of the user, which may then communicate the ISP router of the user 835, which may in turn communicate with the HUB ISP router 840, which then reaches the HUB cloud engine 895 through the HUB web services 880. In an example, the HUB controller device 890, at a predetermined time each day (e.g., 23.59 hours), may send a request to the HUB cloud engine 895 for an update. The HUB controller device 890 may send this information to the cloud engine 895 using an HTTP GET to an “UpdateDevice” action on the web service using a RESTful Interface. The HUB cloud engine 895 may process this information using software logic 850 and save the information in database 860. Database 860 may contain information about the utility systems of the user and other information, such as the heating schedule of the user, payment data, general user data, web application data, utility bill data and device data. The cloud engine 895 may then send updates back to the HUB controller device 890 for any or all of the following: system firmware/software update; update of the heating schedule; update of the heating spend schedule (i.e., how much was spent each day); the cost per minute, which may be used to calculate today's spending; and/or any messages from HUB controls.

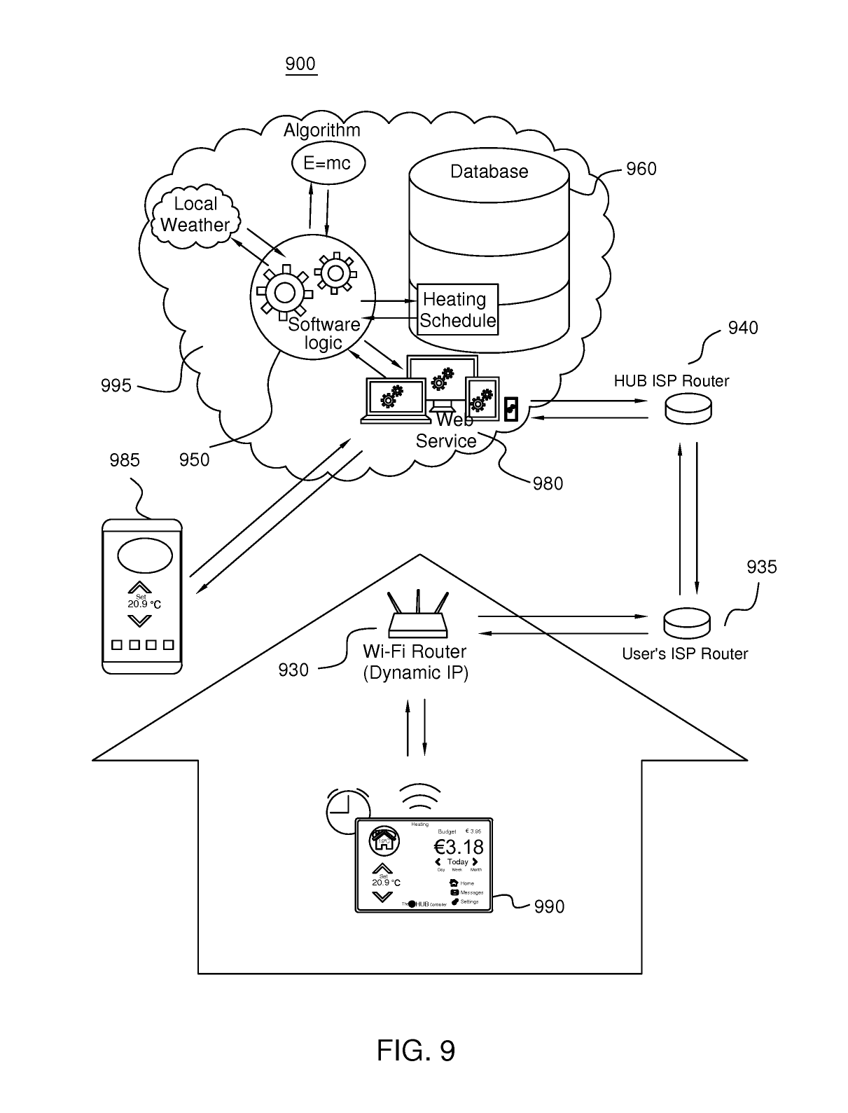

FIG. 9 shows an example of user initiated communications on an external device. The HUB controller may be configured to send an HTTP POST & GET to a “MobileUpdate” action on the web service using a RESTful Interface, containing the ambient temperature and the system status (e.g., 19.3° C., ON) at predetermined intervals (e.g., every 5 minutes). The HTTP GET request may retrieve any new user input. As illustrated in example architecture 900, the HUB controller 990 may communicate with the Wi-Fi router 930 of the user, which may then communicate the ISP router of the user 935, which may in turn communicate with the HUB ISP router 940, which then reaches the HUB cloud engine 995 through the HUB web services 980. As shown in FIG. 8, the user may use a mobile device 985 to open the HUB mobile app and see that his/her homes ambient temperature is 19° C. and that the system is OFF. In an example, the user decides to turn ON the system. This “ON” message may be sent to the HUB cloud engine 995 and the software logic 950 through the web service 980. The system may set an “ON” flag in the database 960 and then attempt to send a message to the HUB controller device 990 so that the device 990 turns the system on. If this message fails due to the dynamic IP, then the cloud engine 995 may wait for the HTTP GET request from the HUB controller device 990 and send a reply containing the “ON” message. Examples of communications that may be made from a mobile, PC, tablet, phablet and the like may include: user turns the heating ON or OFF, and user turns the set temperature up or down.

After adjusting the temperature, the HUB controller may be configured to enter learning mode. During learning mode, the HUB controller may determine how to automatically adjust the settings based on time of day, outside temperatures, motion detection and other factors. After a predetermined learning period has passed, the HUB controller may learn the user's heating schedule and automatically adjust temperatures. When the HUB controller determines that the user wants the system on, it may be configured to send the user an electronic notification (e.g., SMS or e-mail) to a user's email, phone, social media account or other predetermined address to request permission or confirmation to adjust the temperature. The user can confirm the request to turn the system on, e.g., by manually selecting OK on the HUB controller, by responding to the email or text message, or by verbally issuing a command or gesture. If the user confirms that the temperature should be adjusted (e.g., turning on heating) the HUB controller may again go into learning mode. Once a user has confirmed a suggested setting a predetermined number of times (e.g., five times in a row), the HUB controller may be configured to automatically switch the system on the next time.

In another example, the HUB controller may receive user input indicating a budget for temperature control costs. The HUB controller may determine an estimated costs associated with operating an HVAC unit. The HUB controller may make this determination at predetermined intervals. Further, the HUB controller may compare the estimated cost with the budget. If HUB controller determines that the estimated cost equals or exceeds the budget, the HUB controller may then use a wireless communications unit to transmit a request to confirm shutting off the HVAC unit. The request may be in an electronic message or notification to a user, who may receive the message on a predetermined user device, including a personal computer, mobile phone, tablet, phablet, HUB controller (including the HUB controller's touchscreen display), and the like. The electronic message or notification to the user may include an SMS or e-mail to the user's email, phone, social media account or other predetermined address.

The user may then confirm shutting off the HVAC unit and the user device may transmit this confirmation back to the HUB controller. The HUB controller may then deactivate the shunt. As a result, power may be reduced to the HUB controller and an electromechanical valve of an HVAC unit. The power may be reduced to a level such that the HUB controller may remain active but the electromechanical valve may become inactive. When the electromechanical valve becomes inactive, the heating or cooling operations of the HVAC unit may cease.

FIG. 10 shows an example setup procedure for the HUB controller. Before setting up the HUB controller, the user may go to a HUB controls website to enter the serial number of the HUB controller and an e-mail address of the user. Once the HUB controller is installed and connected, the touch screen display may be powered up. As shown in example procedure 1000, the user may be presented with a step-by-step process for setting up the system and may begin the process by clicking on the “Set-up Now” button 1010 at welcome screen 1000a. First, a user may be prompted to adjust the display settings at screen 1000b. The user may also reach the display settings screen 1000b by clicking on the display button in another screen, such as display button 610 in the settings screen shown in FIG. 6. At display settings screen 1000b, the user may use the dimmer 1020 to set the brightness. The user may press the “Next Step” button 1025 to go to the user account settings screen 1000c. The user may also reach the account settings screen 1000c by clicking on the user account button on another screen, such as the user account button 620 in the settings screen shown in FIG. 6. At the account settings screen 1000c, the user may be prompted to enter user account settings. For example the user may enter the User ID and/or e-mail of the user 1031 and a password 1033 through the on screen keypad 1030. The user may press the “Next Step” button 1035 to go to the user Wi-Fi connection screen 1000d. The user may also reach the Wi-Fi connection screen 1000d by clicking on the Wi-Fi button on another screen, such as the Wi-Fi button 630 in the settings screen shown in FIG. 6. At the Wi-Fi connection screen 1000d, a user may be prompted to configure a Wi-Fi connection. For example, the HUB controller will find Wi-Fi networks and the user can scroll through the network(s) found 1041 to make a selection. The user may also manually enter the name of the desired Wi-Fi network 1042 through the on screen keypad 1040. Once the user selects or enters a Wi-Fi network, the user may then enter a password 1043 through the on screen keypad 1040. The user may press the “Test Wi-Fi Connection to HUB” button 1045 to go to the testing connection screen 1000e. Finally, the user may be prompted to test the HUB controller's connection with network. The HUB controller may obtain intelligence through this connection. After successful testing, a confirmation message 1050 may appear on the testing connection screen 1000e and the user may click “Finish Set-up” 1055, which may take the user to the home screen, such as the home screen shown in FIG. 3 and/or FIG. 4.

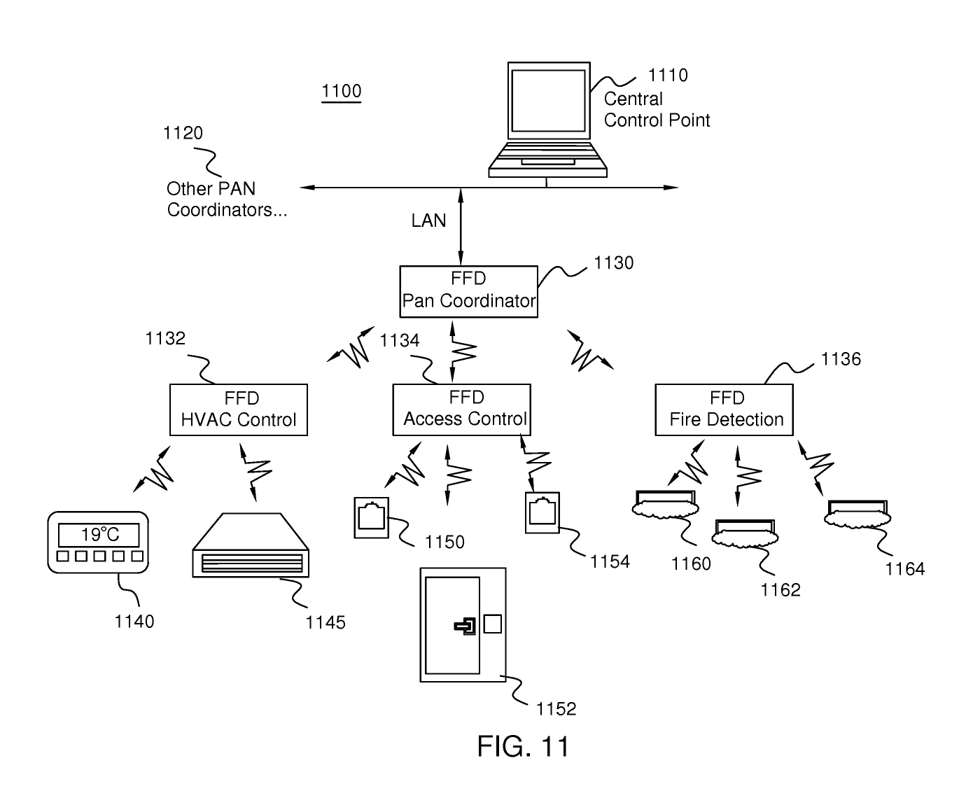

FIG. 11 shows an example home network architecture for use with a HUB controller fitting into an ecosystem. The HUB controller may be configured to operate on a ZigBee network to control multiple devices. As shown in FIG. 11, the HUB controller may control multiple devices through a local area network (LAN) and/or a personal area network (PAN). For example, the HUB controller may control and/or communicate with a hot water thermostat, wireless TRV valves, smart meters, electricity transmitters, Wi-Fi sockets, and Wi-Fi switches. As shown in example architecture 1100, the HUB controller may act as a central control point 1110 and may control and/or communicate with many reduced function devices (RFDs) through several full function device (FFD) controllers and through an FFD PAN coordinator 1130. For example, the HUB controller may act as a central control point 1110 and may control and/or communicate with a temperature sensor 1140 and air conditioning 1145 through an FFD HVAC controller 1132. In another example, the HUB controller may act as a central control point 1110 and may control and/or communicate with a pressure sensor 1150, door entry control 1152 and motion control sensor 1154 through an FFD access controller 1134. In a further example, the HUB controller may act as a central control point 1110 and may control and/or communicate with smoke detectors 1160, 1162 and 1164 through an FFD fire detection controller 1136. In yet another example, the HUB controller may act as a central control point 1110 and may control and/or communicate with other PAN coordinators 1120.

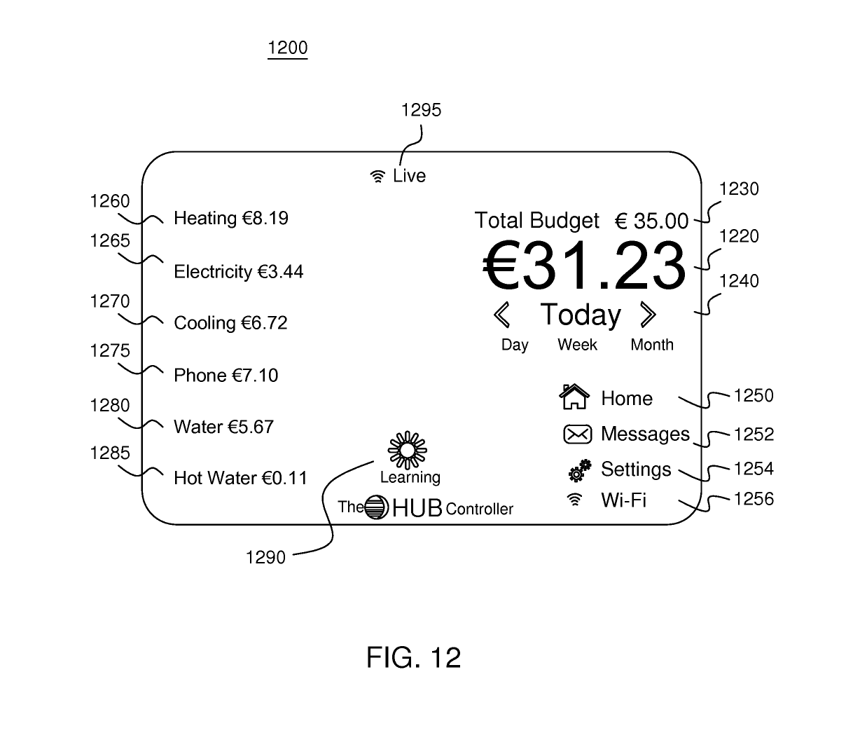

FIG. 12 shows examples of a budget screen of the HUB controller. As shown in example budget screen 1200, the HUB controller may control heating (and/or room heating) 1260, hot water (and/or water heater) 1285, cooling 1270, electricity 1265, phone 1275, water 1280, and/or other utilities. The HUB controller may be configured to control any number of home utility appliances. In addition, the HUB controller may display the individual spend for each utility. For example, as shown in FIG. 12, the HUB controller may display the spend for heating (and/or room heating) 1260, hot water (and/or water heater) 1285, cooling 1270, electricity 1265, phone 1275, water 1280, and/or other utilities. Further, the HUB controller may also display the aggregate spend for all of the utilities 1220. Also, the HUB controller may update the individual and aggregate spend on a minute by minute basis. Heating may be controlled using similar methods described above.

As shown in example budget screen 1200, the HUB controller may display the total budget 1230 for a selected time period, such as today. The time period 1240 may be selected using buttons. In addition, The HUB controller may indicate that it has successfully obtain a Wi-Fi connection with the “Live” icon 1295. The learning spinner 1290 may be configured to appear when the user turns the system on or off, or selects a utility or HUB controller button. For example, the HUB controller may include a home button 1250, messages button 1252, settings button 1254 and Wi-Fi button 1256.

To monitor and control room heating 1260, Wi-Fi enabled thermostatic radiator valves may be paired with the HUB controller. The HUB controller may be configured to control the temperature at which these valves will be shut on or off. The HUB controller may further be configured to display the temperature of each room both on the HUB controller and all mobile devices.

To control and monitor cooling costs 1270, the HUB controller may be operatively coupled to the air conditioning switch system, (e.g., through Wi-Fi (for those units that operate on radio frequencies (RFs)) or connected through the use of a Wi-Fi enabled electric socket). The HUB controller may be configured to calculate the cost by using the energy rating, the cost of that energy and the time the unit is on.

The HUB controller may be configured to monitor and control electricity usage 1265. A Wi-Fi battery electricity sensor may be paired with the HUB controller. This sensor may send the information about total electrical usage in the home, which will display on the HUB controller. Wi-Fi enabled sockets and light switches may also be paired with the HUB controller. These sockets and switches may send information about the energy usage, which may be combined with the energy cost to calculate the energy cost of the appliance. These sockets may allow the HUB controller and mobile application to turn the appliances on or off remotely.

The HUB controller may further control the mobile phone bills 1275 of the household. An application may be embedded in the mobile app that may count the minutes of calls, the locations etc., the number of texts etc. The user may input the tariffs or the app may be linked with the user's mobile service provider account, which may be used to calculate the mobile phone costs. The device may aggregate all users and display on the HUB and its applications to determine household phone costs.

A Wi-Fi enabled valve and flow meter may be paired with the HUB controller to send information on the water usage 1280. The water charge costs may be used to calculate the cost. The HUB controller and mobile apps will also use this device connection to turn off the water if required.

To control and monitor hot water costs 1285, the HUB controller may be operatively coupled to the boiler or hot water heater switch system, (e.g., through Wi-Fi (for those units that operate on radio frequencies (RFs)) or connected through the use of a Wi-Fi enabled electric socket). The HUB controller may be configured to calculate the cost by using the energy rating, the cost of that energy and the time the unit is on.

Although features and elements are described above in particular combinations, one of ordinary skill in the art may appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

1. A method of automatically adjusting temperature, the method comprising:
receiving, by a controller, a user input indicating a budget for temperature control costs;
determining, by the controller, at predetermined intervals, an estimated cost associated with operating a heating, ventilation, and air conditioning (HVAC) unit;
comparing, by the controller, the estimated cost with the budget; and
transmitting, by the controller, an electronic message to a predetermined user device, including a request to confirm shutting off the HVAC unit, based on a determination that the estimated cost equals or exceeds the budget.

2. The method of claim 1, wherein the user input is received on a touchscreen display.

3. The method of claim 1, wherein the user input is received from a personal computer.

4. The method of claim 1, wherein the user input is received from a mobile phone.

5. The method of claim 1, further comprising:
receiving, by the controller, a confirmation to shut off the HVAC unit; and
deactivating, by the controller, an electronic shunt based on the confirmation, wherein the deactivating reduces power received by a processor of the controller and an electromechanical valve of the HVAC unit such that the processor remains active but the electromechanical valve becomes inactive.

6. A method of controlling utility costs, the method comprising:
receiving, by a controller, a user input indicating a budget for home utility costs;
determining, by the controller, at predetermined intervals, an estimated cost associated with each of the plurality of home utility appliances;
determining, by the controller, at predetermined intervals, an aggregated estimated cost associated with the plurality of home utilities based on an aggregation of the estimated cost associated with each of the plurality of home utility appliances;
comparing, by the controller, the aggregated estimated cost with the budget;
shutting off, by the controller, at least one of the plurality of home utility appliances if the aggregated estimated cost equals or exceeds the budget; and
transmitting, by the controller, an electronic notification to a predetermined address notifying a user that at least one of the plurality of home utility appliances has been shut off.

7. The method of claim 6 wherein one of the plurality of home utility appliances is a water heater.

8. The method of claim 6, wherein one of the plurality of home utility appliances is an air conditioner.

9. The method of claim 6 wherein one of the plurality of home utility appliances is a room heater.

10. The method of claim 6 wherein one of the plurality of home utility appliances is an electronic appliance.

11. The method of claim 6 wherein one of the plurality of home utility appliances is a mobile phone.

12. The method of claim 6 wherein the shutting off includes reducing power received by a processor of the controller and an electromechanical valve of the at least one of the plurality of home utility appliances such that the processor remains active but the electromechanical valve becomes inactive.

13. The method of claim 6 further comprising:
displaying, by the controller, the estimated cost associated with each of the plurality of home utility appliances and the aggregated estimated cost associated with the plurality of home utilities.

14. A method of displaying a plurality of utility costs, the method comprising:
determining, by a controller, at predetermined intervals, an estimated cost associated with each of a plurality of home utility appliances;
determining, by the controller, at predetermined intervals, an aggregated estimated cost associated with the plurality of home utilities based on an aggregation of the estimated cost associated with each of the plurality of home utilities; and
displaying, by the controller, the estimated cost associated with each of the plurality of home utility appliances and the aggregated estimated cost associated with the plurality of home utilities.

15. The method of claim 14 wherein one of the plurality of home utility appliances is a water heater.

16. The method of claim 14 wherein one of the plurality of home utility appliances is an air conditioner.

17. The method of claim 14 wherein one of the plurality of home utility appliances is a room heater.

18. The method of claim 14 wherein one of the plurality of home utility appliances is an electronic appliance.

19. The method of claim 14 wherein one of the plurality of home utility appliances is a mobile phone.

20.-38. (canceled)

39. The method of claim 1 wherein the controller comprises a wireless communications unit and a processor, where the user input is received, and the electronic message is transmitted, via the wireless communications unit, and where the estimated cost is determined, and the estimated cost is compared with the budget, by the processor.
